(19) United States
(12) Patent Application Publication
(10) Pub. No.: US 2018/0320786 A1
(43) Pub. Date: Nov. 8, 2018

(54) ARRANGEMENT FOR ACTUATING A SHIFTING ELEMENT

(71) Applicant: ZF Friedrichshafen AG, Friedrichshafen (DE)

(72) Inventors: Thomas PAULI, Tiefenbach (DE); Stefan IGL, Vilshofen (DE); Thomas OBERBUCHNER, Passau (DE); Anton EDER, Hutthurm (DE); Christoph BAUER, Windorf (DE); Stefan MICHL, Hauzenberg (DE); Thomas BAUER, Hauzenberg (DE); Ulf JARCZAK, Deggendorf (DE)

(21) Appl. No.: 15/773,227

(22) PCT Filed: Oct. 5, 2016
(86) PCT No.: PCT/EP2016/073715

§ 371 Date: May 3, 2018

(30) Foreign Application Priority Data
Nov. 9, 2015 (DE) 10 2015 221 999.2

(51) Int. Cl. F16H 63/30

(52) U.S. Cl. CPC F16H 63/3023; F16H 2200/0026; F16H 2063/3079

(57) ABSTRACT

An arrangement for actuating at least one shifting element of a transmission. The arrangement has at least one hydraulically actuated actuating piston (1) for axially moving a shifting fork (2) of the shifting element.

This application is a National Stage completion of PCT/EP2016/073715 filed Oct. 5, 2016, which claims priority from German patent application serial no. 10 2015 221 999.2 filed Nov. 9, 2015.

### FIELD OF THE INVENTION

The present invention relates to an arrangement for actuating at least one shifting element of a transmission.

### BACKGROUND OF THE INVENTION

From automotive technology, arrangements for actuating a shifting element of a transmission are generally known. For example, in range-change transmissions synchronizers and shifting sleeves are actuated by shifting forks which are attached to axially displaceable shifting rails. For the axial movement of the shifting rails, carriers are needed, such that a shifting finger engages in the carrier and an axial movement of the carrier and the shifting rail is brought about by the rotational movement of the shifting finger. In turn, the shifting fingers are fixed to a shifting shaft and are in turn actuated by the latter.

With the known arrangements not only are gear steps engaged, but in addition, for example, a crawling gear shift can be made in order to enable a large step-down ratio of the transmission to be produced, for example in agricultural utility vehicles. The arrangement described above for actuating the shifting elements, for example in order to engage a crawling gear, requires a large number of components and is of complex design.

### SUMMARY OF THE INVENTION

The purpose of the present invention is to propose an arrangement of the type described at the start, which enables shifting elements to be actuated in as simply designed and inexpensive a manner as possible.

According to the invention this objective is achieved by the characteristics specified in the independent claims, while advantageous design features emerge from the subordinate claims and the description and drawings.

Thus, an arrangement for actuating at least one shifting element of a transmission is proposed. To produce a simply designed and inexpensive arrangement, it is provided that at least one actuating piston or suchlike that can be acted upon hydraulically is provided for the axial movement of a shifting fork of the shifting element.

Thus, the arrangement proposed enables a hydraulic shift to be carried out without the need for other components known from the prior art, such as a shifting finger, a carrier and further components. This is achieved in that the actuating piston, as it were, directly actuates for example the shifting rail or the like attached to the shifting fork.

A preferred application of the arrangement proposed provides that with the actuating piston an electro-hydraulic shift can be carried out in a multi-step transmission. However, with the proposed arrangement other shifts too can be carried out without problems, for example between gear steps or suchlike, since the actuating piston actuates synchronizers, shifting or sliding sleeves by way of the shifting fork.

To enable a restoring movement downshift, as simply as possible, it is provided that the actuating piston is functionally connected to a spring-loaded shifting rail that carries the shifting fork. In this way, without additional hydraulic action, a restoration movement or downshift can take place for example by way of a restoring spring when the action of pressure has ended.

A particularly space-saving design of the present invention can provide that the piston space is integrated in the housing of the transmission. For this, for example, at least one housing bore or the like can be provided. The shifting rail in contact with the actuating piston is also guided in a corresponding bore or even in more than one bore of the housing.

For hydraulic actuation of the actuating piston, for example, an electro-hydraulically functioning supply device is provided. The supply device can for example be a valve, such as an electro-hydraulic control valve that is either integrated in the housing or attached to it by means of a valve block. To ensure a supply of hydraulic medium to the piston space, the control valve is in flow connection with the piston space. A space-saving solution can provide that the hydraulic supply takes place by way of housing bores connected to one another. However, it is also conceivable that an external connecting line is led along the outer wall of the housing and connected to the piston space.

To produce a defined displacement or travel path of the actuating piston, in an embodiment of the invention it can for example be provided that the actuating piston has a diameter step or suchlike which is associated with a stop in the piston space. This enables a predetermined displacement path. However other designs too are conceivable for producing the stop or the diameter step on the actuating element. Furthermore, for example in order to allow for manufacturing tolerances in the predetermined travel path, an adjusting washer can be associated with the actuating piston, in particular the diameter step, so that a predetermined travel path of the actuating piston can be set by choosing the thickness of the washer.

### BRIEF DESCRIPTION OF THE DRAWINGS

Below, the present invention is explained further with reference to the drawings, which show:

FIG. 1: A schematic three-dimensional view of an embodiment variant of an arrangement according to the invention, the housing not being shown;

FIG. 2: A schematic sectioned view of the housing with the arrangement according to the invention; and

FIG. 3: A three-dimensional schematic view of the housing with a supply line integrated in the housing.

### DETAILED DESCRIPTION OF THE PREFERRED EMBODIMENTS

The figures show various example embodiments of an arrangement according to the invention for actuating at least one shifting element of a transmission. The arrangement according to the invention comprises an actuating piston 1 that can be acted upon hydraulically for the axial movement of a shifting fork 2 of the shifting element (not shown in further detail) in the form of a synchronizer or a sliding sleeve. Preferably, the proposed arrangement can be used for actuating the shifting element for the electro-hydraulic engagement of a crawling gear in a range-change transmission of an agricultural utility vehicle. However, other applications too are also conceivable.

FIG. 1 shows the proposed arrangement without the housing 3 of the transmission. The actuating piston 1 is in flow connection with a hydraulic supply device. The electro-hydraulic supply device comprises a control valve 4 which, in the version shown in FIG. 1, is in flow connection with a piston space 6 by way of a connecting line 5 that runs along the outside of the housing 3, in which piston space the actuating piston 1 is arranged and can move.

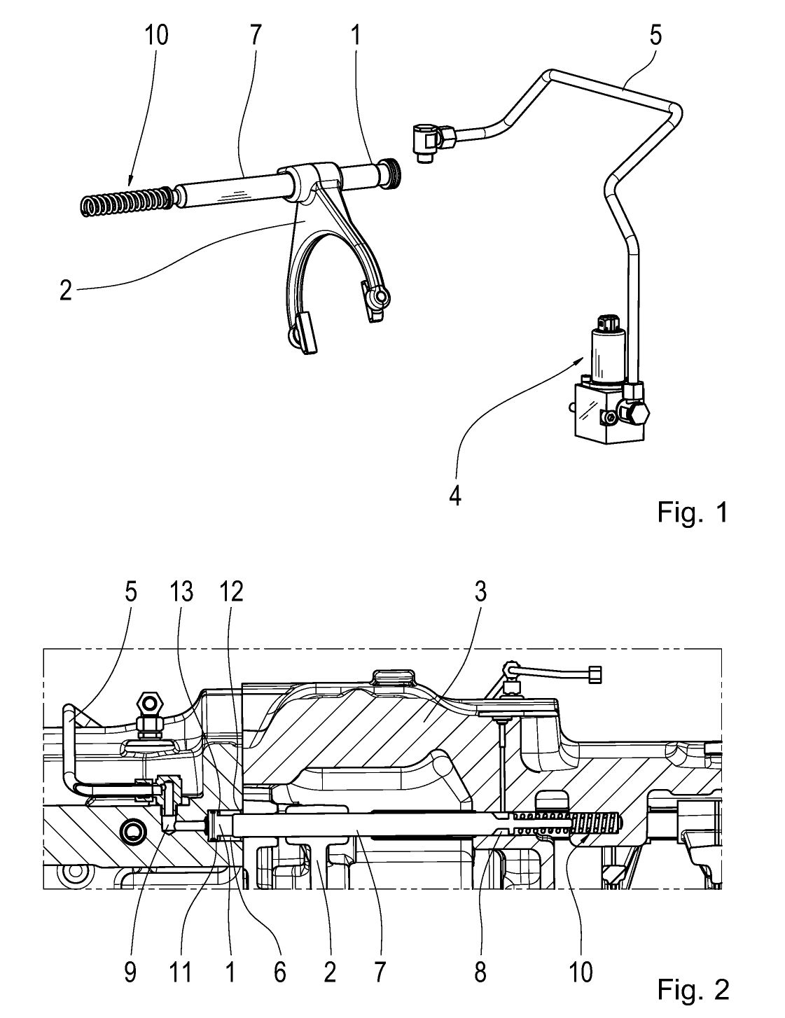

In FIG. 2 it can be seen from the sectional view that the shifting fork 2 for engaging a crawling gear or shifting a gear step is attached in a rotationally fixed manner to an axially displaceable shifting rail 7. The piston space 6 and also a receiving bore 8 for the shifting rail 7 are provided or integrated in the housing 3 of the transmission.

The connecting line 5 of the electro-hydraulic supply device opens into a connecting bore 9 for acting upon the actuating piston 1 arranged in the piston space 6.

A first end of the actuating piston 1 is thus acted upon by hydraulic medium and a second end of the actuating piston 1 is in contact with an end of the shifting rail 7, whereas the end of the shifting rail 7 remote from the actuating piston 1 is in contact with a restoring spring 10 guided in the receiving bore 8 of the housing 3.

By acting with pressure upon the actuating piston 1, the shifting rail 7 is directly moved axially by the actuating piston 1 whereby the shifting fork 2 fixed on the shifting rail 7 also moves axially, so that a shift to the crawling gear or to some other gear is carried out. The shifting rail 7 moves axially against the force of the restoring spring 10, so that when the pressure has ended its action upon the actuating piston 1, the shifting rail 7 undergoes an axial restoration movement due to the restoring spring 10, so that a shift back into the position for road driving or a shift to another gear step takes place.

As can be seen from FIG. 2 in particular, the actuating piston 1 has a diameter step 11 which is associated with a stop 12 in the piston space 6 in order to set a predetermined displacement path or shifting path of the actuating piston 1. To compensate if necessary for tolerances produced during manufacture, an adjusting washer 13 is associated with the diameter step 11, by virtue of which a predetermined travel path for example of 20 mm can be set exactly. Since the housing 3 is divided in the area of the stop 12, the predetermined travel path can be adjusted in a simply designed manner. For example, the division can be produced by different housing components.

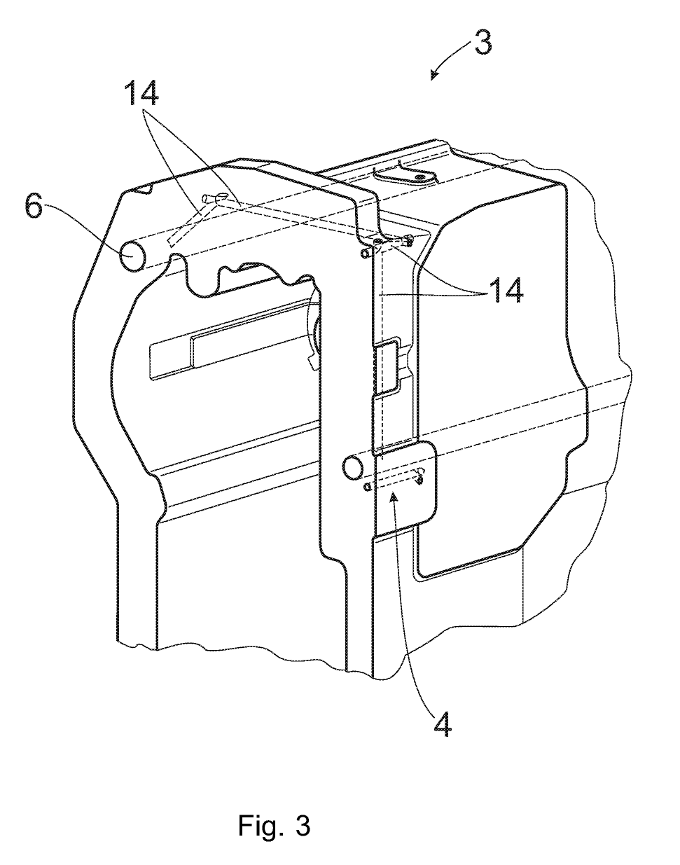

FIG. 3 shows a three-dimensional schematic view of the housing 3 of the transmission, from which it can be seen that a configuration integrated in the housing 3 is possible for the hydraulic connection between the control valve 4 and the piston space 6. For this, a number of housing bores 14 are interconnected in order to provide a flow connection between the control valve 4 and the piston space 6.

### INDEXES

1 Actuating piston
2 Shifting fork
3 Housing
4 Control valve
5 Connecting line
6 Piston space
7 Shifting rail
8 Receiving bore
9 Connecting bore
10 Restoring spring
11 Diameter step
12 Stop
13 Adjustment washer
14 Housing bores

1-10. (canceled)

11. An arrangement for actuating at least one shifting element of a transmission, the arrangement comprising:
at least one hydraulically actuated actuating piston (1) which is provided for axial movement of a shifting fork (2) of the shifting element.

12. The arrangement according to claim 11, wherein the actuating piston (1) that moves the shifting fork (2) is provided for electro-hydraulic engagement of a crawling gear.

13. The arrangement according to claim 11, wherein the actuating piston (1) is functionally connected to a spring-loaded shifting rail (7) that carries the shifting fork (2).

14. The arrangement according to claim 11, wherein the actuating piston (1) is guided within a piston space (6) provided in a housing (3) of the transmission.

15. The arrangement according to claim 14, wherein the actuating piston (1) has a diameter step (11) and the diameter step (11) abuts against a stop (12) in the piston space (6) for setting a predetermined displacement path.

16. The arrangement according to claim 15, wherein an adjustment washer (13) is associated with the diameter step (11).

17. The arrangement according to claim 11, wherein a hydraulic medium acts upon a first end of the actuating piston (1) and an end of the shifting rail (7) is directly in contact with a second end of the actuating piston (1), and an end of the shifting rail (7), remote from the actuating piston (1), is in contact with a restoring spring (10) guided within a receiving bore (8) of the housing (3).

18. The arrangement according to claim 11, wherein the actuating piston (1) is connected to an electro-hydraulic supply device.

19. The arrangement according to claim 18, wherein the electro-hydraulic supply device comprises a control valve (4) which is connected, by way of at least one housing bore (14), to the piston space (6) for acting upon the actuating piston (1).

20. The arrangement according to claim 18, wherein the electro-hydraulic supply device comprises a control valve (4) which is connected, by way of an external connecting line (5) and a connecting bore (9), to the piston space (6) for acting upon the actuating piston (1).

21. An arrangement for actuating at least one shifting element of a transmission, the arrangement comprising:
at least one piston being slidably arranged within an axially extending piston space,
the at least one piston being coaxially aligned with a shifting rail and directly contacting an axial end of the shifting rail,
a shifting fork being fixed to the shifting rail,
the piston space being pressurizable by an electro-hydraulic supply device such that the piston being biased within the piston space, and
the piston axially biasing the shifting rail and the shifting fork which shift the shifting element of the transmission.

22. The arrangement according to claim 21, wherein another axial end of the shifting rail, opposite the at least one piston, engages with a spring which biases the shifting rail in an axial direction toward the at least one piston.

23. The arrangement according to claim 21, wherein the actuating piston (1) that moves the shifting fork (2) provides electro-hydraulic engagement of a crawling gear.
